(19) United States
(12) Patent Application Publication
(10) Pub. No.: US 2014/0089137 A1
(43) Pub. Date: Mar. 27, 2014

(54) SYSTEM AND METHOD FOR DONATING

(71) Applicant: Annetta Johnson, Victorville, CA (US)

(72) Inventor: Annetta Johnson, Victorville, CA (US)

(21) Appl. No.: 13/629,448

(22) Filed: Sep. 27, 2012

(51) Int. Cl. G06Q 50/00

(52) U.S. Cl. CPC G06Q 50/01
USPC 705/26.8; 705/319

(57) ABSTRACT

A method to incentivize and facilitate the donation of literature from a donor to a recipient. The recipient initially pays an access fee, after which, the recipient can communicate literature needs to a donors through a website dedicated to the method. The recipient can post a profile on a website dedicated to the method so that the donor can review potential recipients. Next, the recipient can produce a wish list of desired literature from the recipient. The donor views the requested literature and matches the requested literature with available literature. The donor and recipient communicate to discuss specifics of the donation and other pertinent information. The donor receives benefits such as tax deductions and credits for donating. The donation is then delivered to the recipient. The recipient receives and acknowledges receipt of the donation, and the donor receives a receipt for proof of donating.

### CROSS-REFERENCE TO RELATED APPLICATIONS

The present Utility patent application claims priority benefit of the U.S. provisional application for patent Ser. No. 61/626,494 entitled “Literacy”, filed on Sep. 27, 2011 under 35 U.S.C. 119(e). The contents of this related provisional application are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to donations. More particularly, one or more embodiments of the invention relate to a method of donating literature.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a donation is a gift given by physical or legal persons, typically for charitable purposes and/or to benefit a cause. A donation may take various forms, including cash offering, services, new or used goods including books, clothing, toys, food, and vehicles. Donations also may consist of emergency relief or humanitarian aid items, development aid support, and medical care needs such as blood or organs for transplant.

Typically, charitable contribution deductions for United States Federal Income Tax purposes are defined in section 170(c) of the Internal Revenue Code as contributions to or for the use of certain nonprofit enterprises. An organization must meet certain requirements set forth in the Code. Some organizations must also file a request with the Internal Revenue Service to gain status as a tax-exempt non-profit charitable organization under section 501(c)(3) of the tax code.

Typically, libraries may incur tremendous overhead costs to procure and maintain subscriptions to books, magazines, periodicals, encyclopedias, newspapers and other reading and reference materials needed to maintain library services. These overhead costs deplete the library funds. Donations help libraries defer some of these costs.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a flowchart diagram of the steps for an exemplary method for incentivizing and facilitating donations, in accordance with an embodiment of the present invention;

FIG. 2 illustrates a block diagram for an exemplary method for incentivizing and facilitating donations, in accordance with an embodiment of the present invention; and

FIG. 3 illustrates a typical computer system that, when appropriately configured or designed, can serve as an exemplary method for incentivizing and facilitating donations website in which the invention may be embodied.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The applicants hereby give notice that new Claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hardwired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

A non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; however, the non-transitory computer readable medium does not include a pure transitory signal per se.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

The present invention will now be described in detail with reference to embodiments thereof as illustrated in the accompanying drawings.

There are various types of methods for incentivizing and facilitating donations 100 that may be provided by preferred embodiments of the present invention. In one embodiment of the present invention, the method for incentivizing and facilitating donations 100 may provide a method to incentivize and facilitate the donation of literature 200 from a donor 202 to a recipient 204. In this manner, literacy may be promoted by facilitating the transfer and access of the literature. The literature may include, without limitation, books, e-books, magazines, legal publications, medical publications, technical publications, periodicals, encyclopedias, forms, DVD's, CD's, videos, audio mediums, and the like. However, in other embodiments of the present invention, the donation may be nonliterary including, without limitations, vehicles, clothes, cash, jewelry, blood, land, services performed, and any commonly donated item or service used to promote literacy. Those skilled in the art, in light of the present teachings, will recognize that the donor may include, without limitation, a charitable organization, a nonprofit organization, a publisher, a place of worship, an individual, a philanthropist, a corporation, a government, and a bookstore. The recipient may include a nonprofit organization, an individual, a library, a place of worship, a school, a government, and a medical facility. In some embodiments, the method may require the recipient to pay an access fee, after which, the recipient may communicate literature needs to myriad donors through various means. In some embodiments, the method for donating literature may further allow the donor to identify the needs of myriad recipients and, within capabilities, donate the literature in a targeted, efficient, and beneficial manner. In this manner, the donor may receive at least one benefit 206 for making the donation, including, without limitation, substantial tax deductions, publicity, advertisement, and reduction of overstocked inventory. Conversely, the recipient may also benefit by receiving a variety of literature donations from previously unidentified donors; thereby increasing the availability and quantity of literature while reducing overhead costs. Those skilled in the art, in light of the present teachings, will recognize that a win-win style of transaction may occur, even with noncommercial donations. Those skilled in the art also recognize that technological advancements, including, without limitation, a method for incentivizing and facilitating donations website 208 dedicated to donation transactions, the internet, novel shipping methods, e-literature, e-literature reading devices, smart phones, electronic tax filings, and novel publicity distribution may create an efficient process for identifying and connecting donors to recipients, donating the literature, and identifying and realizing benefits for donations. In some embodiments, the website 208 may include a database for storing items and services available for donation, lists of donors, lists of recipients, information for tax deductions and grants, liability rules, state regulations concerning donations, and pertinent forms. In this manner, the overarching goal of promoting literacy may be enhanced and incentivized.

In some embodiments, the method for incentivizing and facilitating donations may include an initial step 102 of a recipient paying a fee to access the method for incentivizing and facilitating donations. The fee may be utilized for maintaining the website, developing future embodiments of the website, and other administrative costs related to the website. The recipient may then proceed to the step 104 of displaying at least one request for literature. The recipient may provide a list of needed items or services in the website, which stores the list in a database. The donor may then perform the step 106 of identifying the requested literature. The donor may access and review the database to identify appropriate recipients. The next step 108 may involve the donor displaying available literature for donations and distribution. However, in additional embodiments, the above steps may be reversed, whereby the donor lists and categorizes items or services available for donation, and the recipient pays a fee to search and view the list for appropriate donation items and services. Step 110 allows the donor and the recipient to identify each other for further communications. The communications, often through the website, may facilitate the donation process, the selection of gifts, the implication and effect of the tax deduction, and the delivery of the selected gifts. In one embodiment the website may support an exchange of services between the donor and the recipient. For example, without limitation, the donor may donate a puppet show or theater show to a library in exchange for fund raising, and material donations through the website.

In some embodiments, the next step 112 may allow donor to identify and receive at least one benefit for delivering and donating the literature. Step 114 may include delivering the literature to the recipient. A final step 116 may allow the recipient to acknowledge and document that the item or service has been received from the donor with a receipt 210. In this manner, numerous advantages to donating may be realized by the donor, including, without limitation, anonymous donations, targeted donations, traceable donation shipments, documented donation transactions, reduction of overstocked surplice for tax deductions, publicity, marketing, and convenient donation methods. Likewise, the recipient may also realize advantages with the method for incentivizing and facilitating donations, including, without limitation, identification of possible donors, access to a larger variety of literature, and publicity.

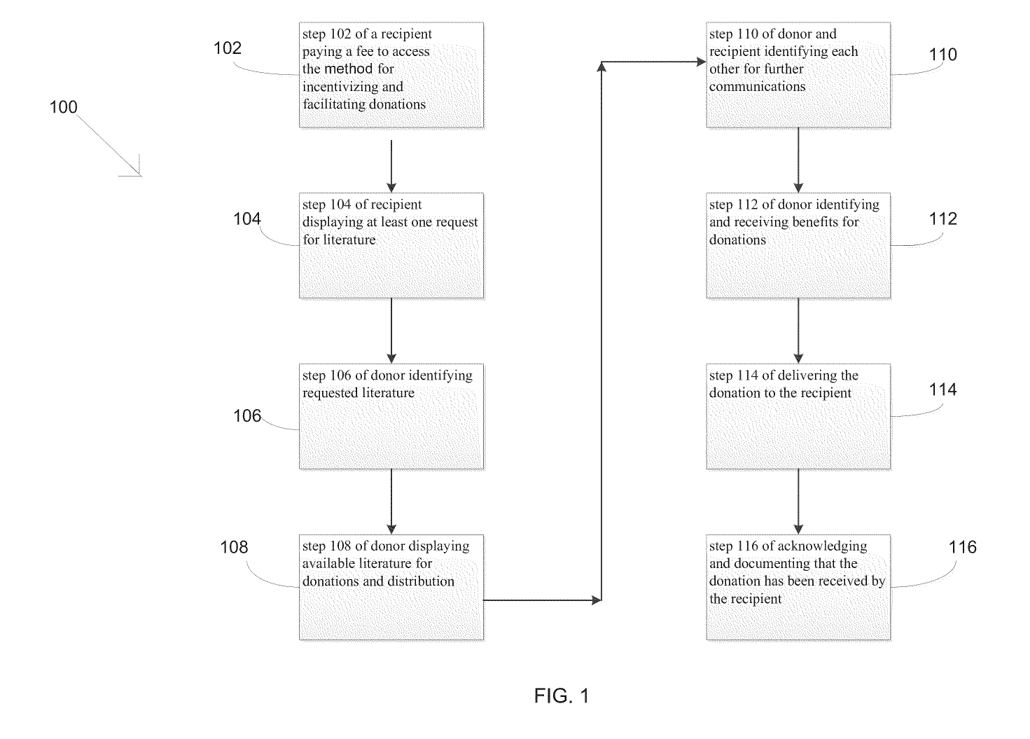

FIG. 1 illustrates a flowchart diagram of the steps for an exemplary method for incentivizing and facilitating donations 100, in accordance with an embodiment of the present invention. The method for incentivizing and facilitating donations may be efficacious for promoting literacy by facilitating the transfer and access of literature. Those skilled in the art, in light of the present teachings, will recognize that a dedicated website may provide an efficient technology for the donor and recipient to meet, communicate, and achieve their desired goals with the method for incentivizing and facilitating donations. However, in other embodiments, the method for incentivizing and facilitating donations may be accessed and performed by other means, including, without limitation, telephone, email, bulletin board, social media sites, and word of mouth. In some embodiments, the method for incentivizing and facilitating donations may include an initial step 102 of a recipient paying a fee to access the method for incentivizing and facilitating donations. The fee may be utilized for maintaining the website, developing future embodiments of the website, and other administrative costs related to the website. In one embodiment, the recipient may include a library that pays a small monthly fee to a website that transacts and facilitates the method for incentivizing and facilitating donations. However, in other embodiments, the donor may donate the maintenance fee on behalf of the recipient. In an alternative embodiment, the donor may also be required to pay a fee for maintenance of the website. Those skilled in the art, in light of the present teachings, will recognize that the recipient and donor may be provided with an access code or similar authentication to access the website. However, in other embodiments, the website may be openly accessible, for free public access.

In one alternative embodiment, the method for incentivizing and facilitating donations may enable the donor or recipient to prepare a profile template. The profile template may provide information parameters useful in matching the donor with the recipient, or in matching the recipient with the donor. A level of privacy may be identified for each information parameter in the profile, which is useful in limiting the dissemination of information.

In some embodiments, the recipient may then proceed to the step 104 of displaying at least one request for literature. In some embodiments, the request may be known as a “Wish List” addressed to no one in particular, but available for all to view. The donor may then perform the step 106 of identifying the requested literature. The donor may have various options for viewing and selecting from the requested materials. The next step 108 may involve the donor displaying available literature for donations and distribution. The donor may then match available items or services for donation with the requested items or services. However, in one alternative embodiment, the above steps may be reversed, whereby the donor lists and categorizes items or services available for donation, and the recipient searches and views the list for an appropriate donation. Those skilled in the art, in light of the present teachings, will recognize that, in many instances, the donor may be provided with a multiplicity of recipients who request the donor's item or service. The donor may then select a specific recipient to donate the item or service to. In one alternative embodiment, the method for incentivizing and facilitating donations may enable inventors to submit ideas, collaborate on projects, advance technology and protect inventions through an intellectual property network which provides inventors equity in companies or patent arrays in exchange for the developments which are then patented, marketed, and licensed with revenue flowing through the companies and patent arrays back to the inventors and other contributors of the system. The system may also be used for existing and donated patents which can be marketed and licensed through the system including granting equity or ownership interest in the patent arrays or companies to owners of the existing or donated patents.

In some embodiments, step 110 may allow the donor and the recipient to identify each other for further communications. For example, without limitation, a medical school donor may target and communicate with a medical school in a third world country that does not have the resources to provide the books to its medical students. The medical school donor may then donate used medical books on a periodical basis, as the newer editions of the books become available. In some embodiments, a formal agreement between the donor and the recipient may be authored to specify the details of the transaction. The agreement may include, without limitation, a trust agreement, the estimated value of the donated items or services, the party responsible for shipping fees, insurance to protect the donated items and services, and liability terms for protecting the donor from damages. In some embodiments, the website may be integrated with the items and services the donor may have available for donation. For example, without limitation, the donor may catalogue on the website or a database particular items or assets based on the contribution area of interest of the donor. The donor, in communication with the recipient, may select a donation by activating a hyperlink to the method for incentivizing and facilitating donation's website. Transparent to the donor, the method for incentivizing and facilitating donations website may then be in communication with the donor and the recipient. The next step 112 may allow the donor to identify and receive benefits for delivering and donating the literature. In some embodiments, the website may provide the donor with possible tax deductions and credits. The website may further include forms for applying for grants that allow the donor to receive discounted shipping costs for donated items. In one alternative embodiment, advertising on the website may be utilized to generate revenue. The advertisements may variably alter to target the recipient and the donor. In one alternative embodiment, the donor's donation may be publicized to achieve goodwill with the public, and to provide advertising for the donor. For example, without limitation, the website may trigger a call to a radio station whenever the donor donates an item or service, whereby the radio station makes an announcement on the air regarding the donation.

In one alternative embodiment, the method for incentivizing and facilitating donations website may include a computer system capable of identifying whether the item or service is tax deductible. In this manner, the donor may make donation decisions based on whether the item or recipient provides tax benefits. In some embodiments, the donor may include a company with overstocked items. The company may sell the items to the recipient for a discounted rate. The company may be required to pay a monthly fee to receive access to recipients who would purchase the overstocked items.

In some embodiments, step 114 may include delivering the literature to the recipient. In some embodiments, the donor may apply for grants to reduce or eliminate shipping costs for the donations. Those skilled in the art will recognize that e-literature eliminates shipping costs, and may further enhance the method for incentivizing and facilitating donations. In some embodiments, a final step 116 may allow the recipient to acknowledge and document that the item or service has been received from the donor. In some embodiments, a receipt 210 for the transaction may be generated, and delivered to the donor for record keeping and tax purposes. The recipient may also be notified of the purchase, information provided by receipt, and dates, shipping information, and any other pertinent information to the transfer of the purchased materials made to the recipient. In some embodiments, the website may generate receipts, along with the tax deductible amount receipts and offer a general contract for performance between the donor and the recipient. In other embodiments, a report of activity may be generated by the website, including, without limitation, an itemized list of all items and services donated, the estimated value of the items, dates, shipping costs, terms of the transaction, and tax deductions. In one embodiment, the donor may agree that in the event that the literature is no longer needed, the recipient will redonate the literature to a new recipient through the website. In this manner, the original recipient becomes the new donor, and the literature is transferred once again for further promotion of literacy.

In one alternative embodiment, the method for incentivizing and facilitating donations may be utilized to borrow items or services, rather than donate. In this manner, the donor is merely loaning the item or service, and expects to have the item or service returned by the recipient at an agreed upon time. In one alternative embodiment, the recipient may include a school district with a budget shortfall. The school may receive books, monetary donations, and volunteer teachers from the general public in the school's district, which serve as the donors. In yet a further alternative embodiment, the donation website may be accessible through an app on a smart phone, whereby the donor and recipient may view the donation transaction in real time.

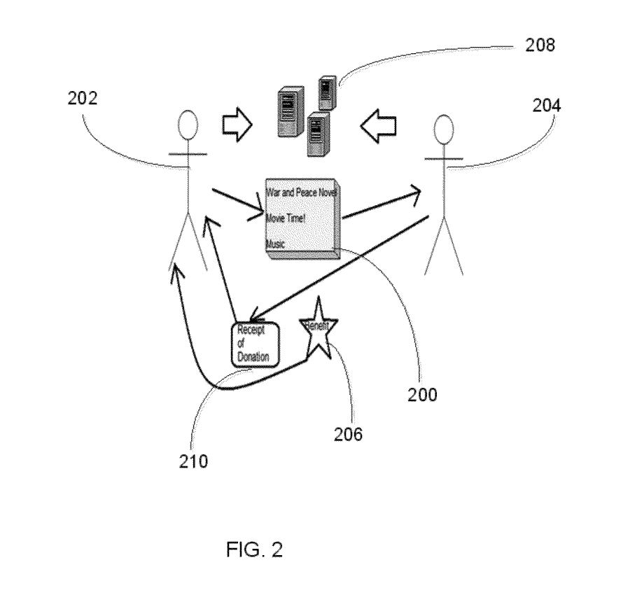

FIG. 2 illustrates a block diagram for an exemplary method for incentivizing and facilitating donations, in accordance with an embodiment of the present invention. In some embodiments, the method for incentivizing and facilitating donations may be utilized through the method for incentivizing and facilitating donations website. For example, without limitation, the website may include queries to a database that identifies key words that may be googled, or searched by natural language to find the desired donated item or service. Initially, the donor or recipient may access the website to arrive at an Introduction Page, Purpose Page, and How-To Instructions for accessing the various aspects of the method for incentivizing and facilitating donations website. The recipient may complete an information form, indicating name of the entity or individual, purpose and function of their business, address and phone number, and any other contact information. The recipient may then decide whether to join the website, and if so, agree to the monthly service charge to access and receive donations. The recipient may further establish a user name and password. The donor may complete a similar information form indicating name of the entity or individual, purpose and function of the business, address and phone number and any other contact information for the business. The donor may then read and understand the terms of the website, and agree to move forward as a potential donor, or not agree to participate. If the donor wishes to access website, the donor may establish a User Name and Password, or other form of authentication. Once the donor and the recipient have been accepted by the website, they may access a “wish lists” established by the recipient. The recipient may list desired literacy materials. The donor may receive and input specific information on the literacy materials available for donation. However, the donor may also ascertain the website information of what specific literacy materials can be ordered and are being requested from specific recipients. In this manner, the donor may select the appropriate recipient and item to donate. The donor may also choose to make a monetary donation to the recipient. In some embodiments, the website may seek to establish the most expedient route for the donor to identify the appropriate recipient based on the type of literacy material, the specifics of the materials, services or monetary request to be donated or needed.

In some embodiments, a local community link may be established to allow community donors to connect with community recipients. However, in other embodiments, a general link to recipients and donors may be established whenever items and services are inputted into the itemization of “Literacy Goods Desired to be Donated”. In this case, the website may attempt to match items to appropriate donors and recipients. When a match of literacy donations is made, the website may allow for an offer by the donor. The offer may then be accepted or refused by the recipient. When a potential match of literacy donations is made, the website may allow for a wish list and literacy items needed and requested by the recipient. The requests may then be donated by the donor. When a match of literacy donations is made, information between the donor and the recipient may be provided.

In some embodiments, the donor may choose to be anonymous or disclose their identity. The recipients may determine the method of movement of donated items through website alternatives; suggested dates for transfer will be established, and if a purchase is made by the donor on behalf of the recipient, then such information may be inputted and purchased through the website, through a third party literacy provider, such as, without limitation, a magazine subscriber. The purchase information may then be provided to both donor and recipient. When a match is established, the website may provide tax deductible information as to deductible value of the items being donated by the donor. When a match is established, the website may then allow for specific information of mailing, drop-off donations, donations to be transported through participating charitable institutions, and any additional form of match movement of literacy materials.

In some embodiments, the recipient's wish list may be very general in nature, requesting books to be sold to obtain revenue for the library. However, in other embodiments, the wish list may include very specific needs, such as, without limitation, rare periodical by date, volume. Similarly, the donor's offers of literacy materials may be very general in nature, such as offering to purchase several magazine subscriptions to several libraries; or very specific in nature, offering a rare book to a recipient requesting such material such as a university or specialized school. If the donor is purchasing literacy materials on behalf of the recipient, contact may be made directly between the donor and a literacy provider, such as a magazine subscriber service, purchase made through the website, money transaction made through the website, and receipt for purchase given to the donor for the literacy materials purchased. The recipient may be notified of the purchase, information provided by receipt, and dates, shipping information, and any other pertinent information to the transfer of the purchased materials made to the recipient. In some embodiments, the website may generate receipts, along with the tax deductible amount receipts and offer a general contract for performance between the donor and the recipient. The donors or the recipient may then log off of the website after completing the donation transaction, or they may continue looking for another donor or recipient.

In one alternative embodiment, the method for incentivizing and facilitating donations may facilitate the transfer of items that are antiquated or out-of-production. For example, without limitation, a camera part for a camera may be out-of-production. The company may have stopped carrying camera parts for outdated systems, items, components within a few years of manufacture, largely due to limited storage space. Often the part is desired by consumers or those holding and wishing to repair and use the original item. However, a method for finding the original/used but outdated part is not available. The method for incentivizing and facilitating donations website could be modified to a donor/recipient medium for the giveaway and exchange of such antiquated and out-of-production parts. Additional examples of items may include household item parts, automotive parts, aerospace components and parts, toy and game parts, furniture manufacture parts, landscape components and parts. Those skilled in the art will recognize that the primary difference in the use of the website for such donor/recipient exchange possibly eliminates the charitable status, and thus, ability to qualify for tax exemption receipts. However, this embodiment may be efficacious for the recycling and environmental assistance of unused components.

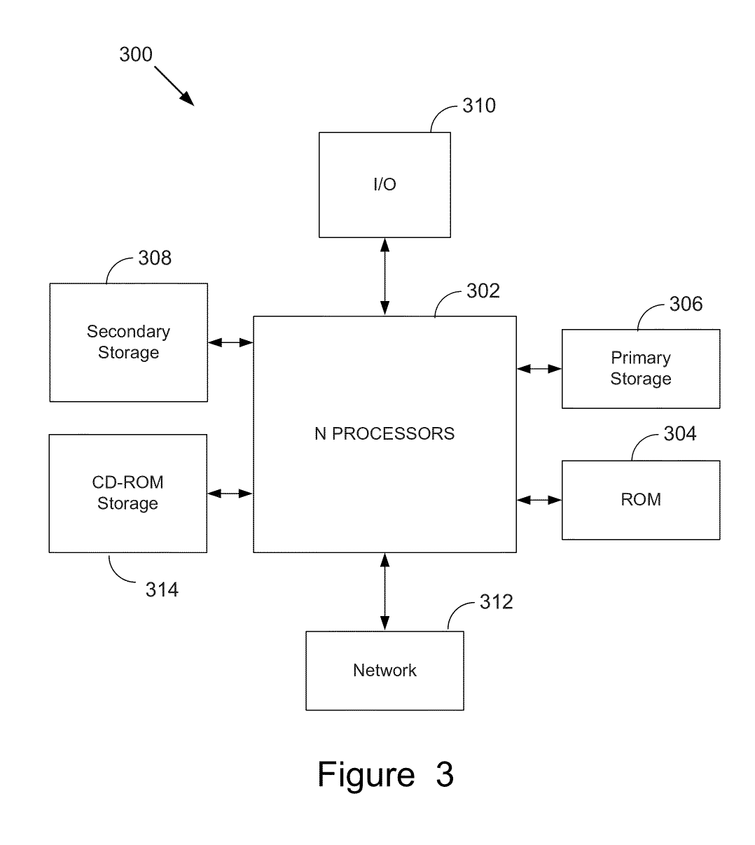

FIG. 3 illustrates a typical computer system that, when appropriately configured or designed, can serve as a computer system in which the invention may be embodied. The computer system 300 includes any number of processors 302 (also referred to as central processing units, or CPUs) that are coupled to storage devices including primary storage 306 (typically a random access memory, or RAM), primary storage 304 (typically a read only memory, or ROM). CPU 302 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 304 acts to transfer data and instructions uni-directionally to the CPU and primary storage 306 is used typically to transfer data and instructions in a bi-directional manner. Both of these primary storage devices may include any suitable computer-readable media such as those described above. A mass storage device 308 may also be coupled bi-directionally to CPU 302 and provides additional data storage capacity and may include any of the computer-readable media described above. Mass storage device 308 may be used to store programs, data and the like and is typically a secondary storage medium such as a hard disk. It will be appreciated that the information retained within the mass storage device 308, may, in appropriate cases, be incorporated in standard fashion as part of primary storage 306 as virtual memory. A specific mass storage device such as a CD-ROM 314 may also pass data uni-directionally to the CPU.

CPU 302 may also be coupled to an interface 310 that connects to one or more input/output devices video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 302 optionally may be coupled to an external device such as a database or a computer or telecommunications or internet network using an external connection as shown generally at 312, which may be implemented as a hardwired or wireless communications link using suitable conventional technologies. With such a connection, it is contemplated that the CPU might receive information from the network, or might output information to the network in the course of performing the method steps described in the teachings of the present invention.

All the features or embodiment components disclosed in this specification, including any accompanying abstract and drawings, unless expressly stated otherwise, may be replaced by alternative features or components serving the same, equivalent or similar purpose as known by those skilled in the art to achieve the same, equivalent, suitable, or similar results by such alternative feature(s) or component(s) providing a similar function by virtue of their having known suitable properties for the intended purpose. Thus, unless expressly stated otherwise, each feature disclosed is one example only of a generic series of equivalent, or suitable, or similar features known or knowable to those skilled in the art without requiring undue experimentation.

Having fully described at least one embodiment of the present invention, other equivalent or alternative methods of implementing a method for incentivizing and facilitating donations between a donor and a recipient according to the present invention will be apparent to those skilled in the art. Various aspects of the invention have been described above by way of illustration, and the specific embodiments disclosed are not intended to limit the invention to the particular forms disclosed. The particular implementation of the method for incentivizing and facilitating donations between a donor and a recipient may vary depending upon the particular context or application. By way of example, and not limitation, the method for incentivizing and facilitating donations between a donor and a recipient described in the foregoing were principally directed to donations of literature implementations; however, similar techniques may instead be applied to loaning items or services for a small fee through a website, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. One or more computer storage media storing computer-usable instructions, that when used by one or more computing devices, cause the one or more computing devices to perform a method comprising the steps of:
(a) paying a fee to access said method;
(b) displaying at least one request for a donation;
(c) identifying said at least one request for said donation;
(d) displaying said donation that is available;
(e) identifying a donor and a recipient;
(f) receiving at least one benefit for donating said donation;
(g) delivering said donation; and
(h) documenting reception of said donation.

2. The method of claim 1, in which said donation comprises literature.

3. The method of claim 2, in which step (a) further comprises said recipient paying said fee to access said method.

4. The method of claim 3, in which step (b) further comprises a website for displaying said at least one request for said donation.

5. The method of claim 4, in which said website comprises an Introduction page, a Purpose page, and a How-To Instructional page.

6. The method of claim 5, in which in which step (b) further comprises said recipient providing a viewable profile on said website.

7. The method of claim 6, in which step (c) further comprises said donor identifying said at least one requested donation.

8. The method of claim 7, in which said at least one requested donation comprises a wish list.

9. The method of claim 8, in which step (d) further comprises said website for displaying said donation that is available for donation.

10. The method of claim 9, in which step (d) further comprises said donor matching said at least one requested donation with said donation that is available for donation.

11. The method of claim 10, in which step (e) further comprises said donor and said recipient identifying each other through said website.

12. The method of claim 11, in which in which step (e) further comprises said donor and said recipient agreeing on specifics for transfer of said donation.

13. The method of claim 12, in which step (f) further comprises said donor receiving said at least one benefit for donating said donation.

14. The method of claim 13, in which said at least one benefit comprises a tax deduction.

15. The method of claim 14, in which step (g) further comprises said donor delivering said donation to said recipient.

16. The method of claim 15, in which step (g) further comprises said recipient paying a delivery and/or shipping fee for said donation.

17. The method of claim 16, in which step (h) further comprises said recipient acknowledging and documenting reception of said donation.

18. The method of claim 17, in which step (h) further comprises said donor receiving a receipt for proof of donating said donation.

19. A system for incentivizing and facilitating donations comprising:
means for paying a fee to access a method for incentivizing and facilitating donations;
means for displaying at least one request for a donation;
means for identifying said at least one request for said donation;
means for displaying said donation that is available;
means for identifying a donor and a recipient;
means for receiving at least one benefit for donating said donation;
means for delivering said donation; and
means for documenting donation and reception of said donation.

20. A non-transitory program storage device readable by a machine tangibly embodying a program of instructions executable by the machine to perform a method for Donating, the storage device comprising:
(a) computer code for paying a fee to access said method;
(b) computer code for displaying at least one request for a donation;
(c) computer code for identifying said at least one request for said donation;
(d) computer code for displaying said donation that is available;
(e) computer code for identifying a donor and a recipient;
(f) computer code for receiving at least one benefit for donating said donation;
(g) computer code for delivering said donation; and
(h) computer code for documenting reception of said donation.
